(19) United States
(12) Patent Application Publication
(10) Pub. No.: US 2026/0367582 A1
(43) Pub. Date: Nov. 19, 2026

(54) WEARABLE ELECTRONIC DEVICE INCLUDING DISPLAY PANEL AND CONTROL METHOD THEREOF

(71) Applicant: SAMSUNG ELECTRONICS CO., LTD., Suwon-si (KR)

(72) Inventors: Taesan KIM, Suwon-si (KR); Kijung KIM, Suwon-si (KR); Shinhun MOON, Suwon-si (KR)

(73) Assignee: SAMSUNG ELECTRONICS CO., LTD., Suwon-si (KR)

(21) Appl. No.: 19/736,540

(22) Filed: Jul. 9, 2026

Related U.S. Application Data
(63) Continuation of application No. PCT/KR2025/000347, filed on Jan. 7, 2025.

(30) Foreign Application Priority Data
Jan. 9, 2024 (KR) 10-2024-0003855
Feb. 20, 2024 (KR) 10-2024-0024052

(51) Int. Cl. G04G 17/04; H04M 1/02

(52) U.S. Cl. CPC G04G 17/045; H04M 1/0274; H04M 1/0277; H04M 2250/12

(57) ABSTRACT

A wearable electronic device configured to be worn on a wrist of a user, includes a frame having a connection opening therein; a first display panel at a front side of the frame; a second display panel at a lateral side of the frame; and a first printed circuit board inside the frame and connected to the first display panel and the second display panel. The connection opening is at least partially covered by the second display panel. The wearable electronic device includes a first flexible connection member connecting the second display panel and the first printed circuit board through the connection opening.

### CROSS-REFERENCE TO RELATED APPLICATIONS

This application is a continuation of International Application No. PCT/KR2025/000347, filed on Jan. 7, 2025, which is based on and claims priority to Korean Patent Application No. 10-2024-0003855, filed on Jan. 9, 2024, in the Ministry of Intellectual Property of the Republic of Korea, and Korean Patent Application No. 10-2024-0024052, filed on Feb. 20, 2024, in the Ministry of Intellectual Property of the Republic of Korea, the disclosures of which are incorporated by reference herein in their entireties.

### BACKGROUND

### 1. Field

The disclosure relates to a wearable electronic device, and more particularly, to a wearable electronic device including a display panel.

### 2. Description of Related Art

An electronic device may refer to a device that performs a specific function according to a mounted program, such as home appliances, electronic organizers, portable multimedia players, mobile communication terminals, tablet PCs, video/audio devices, desktop/laptop computers, or vehicle navigation systems. Further, a recent electronic device is being proposed as a wearable electronic device in the form of a smart watch which may be worn on a body part (e.g., a wrist, an ankle, etc.). Such wearable electronic devices may output stored information as sound or image.

As the integration density of electronic devices increases along with their speed, high-capacity wireless communication becomes common, recently, various functions may be mounted on a single electronic device such as a mobile communication terminal. For example, not only a communication function but also an entertainment function such as a game, a multimedia function such as music/video playback, a communication and security function such as mobile banking, and a schedule management or electronic wallet function are being integrated into a single electronic device. These electronic devices have been downsized to be conveniently carried by users.

### SUMMARY

According to an aspect of the disclosure, a wearable electronic device configured to be worn on a wrist of a user, includes a frame having a connection opening therein, a first display panel at a front side of the frame, a second display panel at a lateral side of the frame and at least partially covering the connection opening, a first printed circuit board inside the frame and connected to the first display panel and the second display panel.

According to an aspect of the disclosure, a wearable electronic device includes a first display panel, a first sensor, a second display panel,, a second sensor, at least one processor, and memory storing instructions. The instructions may, when executed by the at least one processor individually or collectively, cause the wearable electronic device to display information through the first display panel and/or the second display panel, sense a gesture input on the first display panel through the first sensor, and sense a gesture input on the second display panel through the second sensor, so that a user interface (UI) of the wearable electronic device may be displayed through the first display panel and the second display panel.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to one or more embodiments;

FIG. 2 is a perspective view illustrating a wearable electronic device illustrating a front side of the wearable electronic device according to one or more embodiments of the disclosure;

FIG. 3 is a perspective view illustrating a wearable electronic device illustrating a rear side of the wearable electronic device according to one or more embodiments of the disclosure;

FIG. 4 is a perspective view illustrating a wearable electronic device illustrating a first display panel and a second display panel according to one or more embodiments of the disclosure;

FIG. 5 is a partial cross-sectional view illustrating a wearable electronic device according to one or more embodiments of the disclosure, taken along line A-A′ illustrated in FIG. 4;

FIG. 6 illustrates a second display module according to one or more embodiments of the disclosure;

FIG. 7 is a cross-sectional view illustrating a wearable electronic device according to one or more embodiments of the disclosure, taken along line B-B′ illustrated in FIG. 4;

FIG. 8 is a partial cross-sectional view illustrating a wearable electronic device according to one or more embodiments of the disclosure, taken along line A-A′ illustrated in FIG. 4;

FIG. 9 illustrates a second display module according to one or more embodiments of the disclosure;

FIG. 10 is a block diagram illustrating a portion of a wearable electronic device according to one or more embodiments of the disclosure;

FIG. 11 is a front view illustrating a wearable electronic device illustrating display areas of a first display panel and a second display panel according to one or more embodiments of the disclosure;

FIG. 12 illustrates a user gazing at an area of a second display panel according to one or more embodiments of the disclosure;

FIGS. 13, 14, and 15 are perspective views illustrating a wearable electronic device illustrating images displayed through a second display panel according to one or more embodiments of the disclosure;

FIG. 16 is a view illustrating that an indicator of an application displayed on a first display panel is displayed on a second display panel by a gesture of a user according to one or more embodiments of the disclosure;

FIG. 17 is a view illustrating that an application execution screen corresponding to an indicator displayed on a second display panel is displayed on a first display panel by an input of a user according to one or more embodiments of the disclosure;

FIG. 18 is a view illustrating that an application execution screen is displayed on a first display panel by an input of a user on an indicator displayed on a second display panel according to one or more embodiments of the disclosure; and

FIG. 19 is a view illustrating that a function of a wearable electronic device is performed by a gesture of a user corresponding to a guide indicator displayed on a second display panel according to one or more embodiments of the disclosure.

### DETAILED DESCRIPTION

The following description of the accompanying drawings may provide an understanding of various exemplary implementations of the disclosure including the claims and their corresponding contents. The specific embodiments disclosed in the following description entail various specific details to aid understanding, but are regarded as one of various embodiments. Accordingly, it will be understood by those skilled in the art that various changes and modifications may be made to the various implementations described in the disclosure without departing from the scope and spirit of the disclosure. Further, descriptions of well-known functions and configurations may be omitted for clarity and conciseness.

The terms and words used in the following description and claims are not limited to the bibliographical meaning, but may be used to clearly and consistently describe an embodiment of the disclosure. Therefore, it will be apparent to those skilled in the art that the following description of various implementations of the disclosure is provided only for the purpose of description, not for the purpose of limiting the disclosure defined as the scope of the claims and equivalent thereto.

It should be understood that the singular forms “a”, “an”, and “the” include plural meanings unless the context clearly indicates otherwise. Thus, as an example, “a component surface” may be interpreted as including one or more of the surfaces of a component.

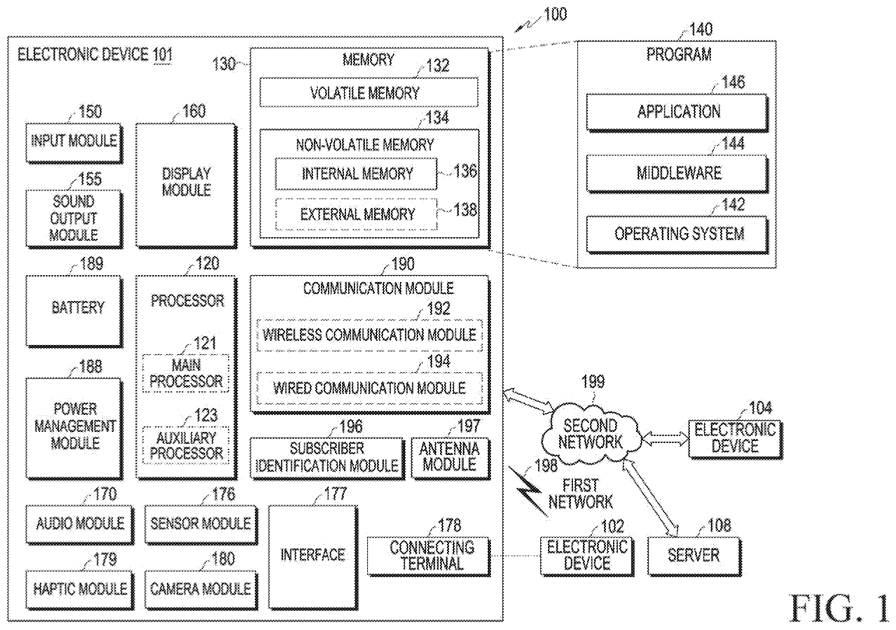

FIG. 1 is a block diagram illustrating an electronic device 101 in a network environment 100, according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least a portion of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least a portion of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least a portion of the function or the service. The one or more external electronic devices receiving the request may perform the at least a portion of the function or the service requested, or an additional function or an additional service related to the request, and transfer an outcome of the performing to the electronic device 101. The electronic device 101 may provide the outcome, with or without further processing of the outcome, as at least a portion of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least a portion of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

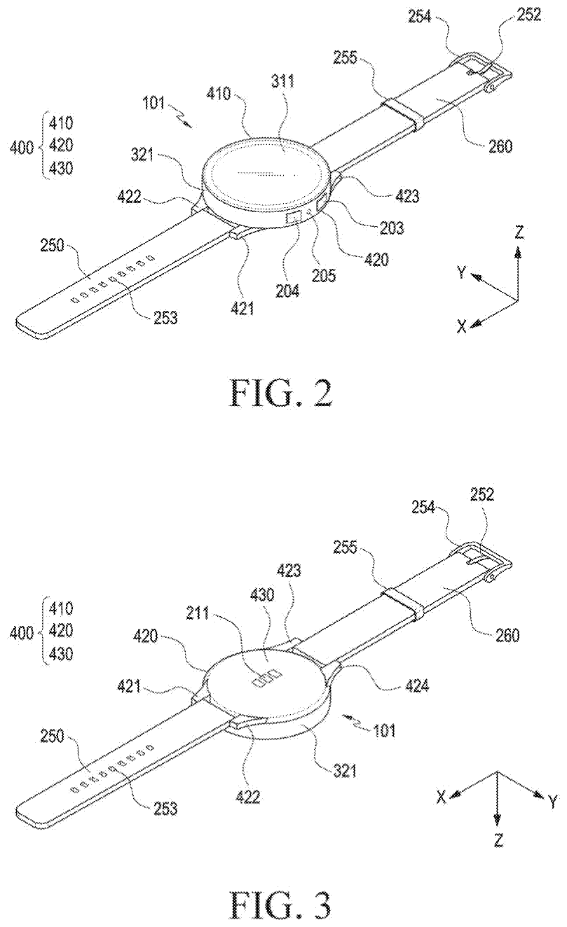

FIG. 2 is a perspective view illustrating a wearable electronic device 101 (e.g., the electronic device 101 of FIG. 1) illustrating a front side of the wearable electronic device 101 according to one or more embodiments of the disclosure. FIG. 3 is a perspective view illustrating the wearable electronic device 101 illustrating a rear side of the wearable electronic device 101 according to one or more embodiments of the disclosure.

Referring to FIGS. 2 and 3, a wearable electronic device 101 according to one or more embodiments of the disclosure may include a frame 400. The frame 400 may include a front part 410. The frame 400 may include a rear part 420 coupled to the front part 410. As an example, the rear part 420 may be coupled to a rear side of the front part 410. As an example, the front part 410 may form one side (e.g., a front side) of the frame 400, and the rear part 420 may form another side (e.g., a rear side) of the frame 400.

According to one or more embodiments of the disclosure, the frame 400 may include a cover part 430. The cover part 430 may be coupled to the rear part 420. The cover part 430 may be disposed to face the first display panel 311. The cover part 430 may cover one side of the inner space of the frame 400. A sensor module 211 may be disposed on the cover part 430.

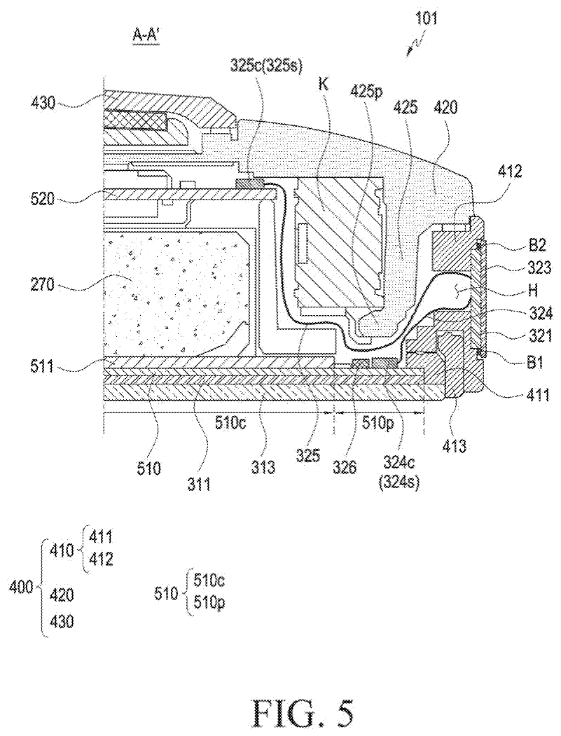

According to one or more embodiments of the disclosure, the frame 400 may form an inner space. As an example, the inner space of the frame 400 may include a space surrounded by the front part 410, the rear part 420, and the cover part 430 of the frame 400. Electronic components (e.g., the battery 270 of FIG. 5) of the wearable electronic device 101 may be disposed in the inner space of the frame 400. In one or more embodiments, the front part 410 and the rear part 420 of the frame 400 may extend in an annular shape to surround the inner space.

According to one or more embodiments of the disclosure, the frame 400 may support the first display panel 311 and the second display panel 321. The first display panel 311 may be disposed at a front side of the frame 400. The second display panel 321 may be disposed at a lateral side of the frame 400. As an example, at least a portion of an edge of the first display panel 311 may be supported by the front part 410 of the frame 400. As an example, the second display panel 321 may surround the front part 410 of the frame 400 and may be supported by a side portion of the front part 410.

According to one or more embodiments of the disclosure, the rear part 420 of the frame 400 may include a plurality of (e.g., four) connection parts 421, 422, 423, 424. A wearing member 250, 260 may be connected to the wearable electronic device 101 through the connection parts 421, 422, 423, 424. As an example, the plurality of connection parts 421, 422, 423, 424 may protrude outward from the rear part 420.

According to one or more embodiments of the disclosure, the wearable electronic device 101 may include a wearing member 250, 260. The wearing member 250, 260 may be connected to the connection parts 421, 422, 423, 424 of the frame 400. The wearable electronic device 101 may be configured to be detachably fastened to a body part (e.g., a wrist, an ankle, etc.) of a user through the wearing member 250, 260.

According to one or more embodiments of the disclosure, the wearing member 250, 260 may be formed of various materials and shapes. A uni-body structure or multiple unit links which is flexible may be formed of fabric, leather, rubber, urethane, metal, ceramic, or a combination of at least two thereof.

According to one or more embodiments of the disclosure, the wearing member 250, 260 may include one or more of a fixing member 252, a fixing member engaging hole 253, a band guide member 254, and a band fixing ring 255. The fixing member 252 may be configured to allow the housing 210 and the wearing members 250 and 260 to be fastened to the user's body portion (e.g., wrist or ankle). The fixing member engaging hole 253 may correspond to the fixing member 252 to fix the housing 210 and the wearing members 250 and 260 to the user's body part. The band guide member 254 may be configured to restrict movement of the fixing member 252 to a certain range when the fixing member 252 fits into one of the fixing member engaging holes 253, thereby allowing the wearing members 250 and 260 to be tightly fastened onto the user's body portion. The band fixing ring 255 may limit the range of movement of the wearing members 250 and 260, with the fixing member 252 fitted into one of the fixing member engaging holes 253.

According to one or more embodiments of the disclosure, the wearable electronic device 101 may include one or more of an audio module(e.g., the audio module 170 of FIG. 1), a sensor module 211 (e.g., the sensor module 176 of FIG. 1), or a key input device 203, 204 (e.g., the input module 150 of FIG. 1). In one or more embodiments, the wearable electronic device 101 may omit at least one of the components (e.g., the key input device 203, 204, or the sensor module 211) or may additionally include another component.

According to one or more embodiments of the disclosure, the wearable electronic device 101 may include a microphone hole 205. A microphone for acquiring external sounds may be disposed in the microphone hole 205. In one or more embodiments, a plurality of microphones may be disposed to detect the direction of the sound.

According to one or more embodiments of the disclosure, the key input device 203, 204 may include a side key button 203, 204 disposed on a side portion of the frame 400. According to one or more embodiments of the disclosure, the wearable electronic device 101 may not include some or all of the mentioned key input devices 203, 204, and the key input device 202, 203, 204 not included may be implemented in another form, such as a soft key, on the second display panel 321. The key input device 203, 204 may be electrically connected to the sensor module 211 of the wearable electronic device 101. The wearable electronic device 101 may measure a bio-signal and biometric information of a user using an electrical signal when a body part of the user contacts the key input device 203, 204.

According to one or more embodiments of the disclosure, the wearable electronic device 101 may include the first display panel 311. The first display panel 311 may visually display information of the wearable electronic device 101 to an outside. The first display panel 311 may be combined with or disposed adjacent to a touch sensing circuit, a pressure sensor capable of measuring a touch intensity (pressure), and/or a fingerprint sensor.

According to one or more embodiments of the disclosure, the wearable electronic device 101 may include the second display panel 321. The second display panel 321 may be configured to be flexible. The second display panel 321 may visually display information of the wearable electronic device 101 to an outside. The second display panel 321 may be combined with or disposed adjacent to a touch sensing circuit, a pressure sensor capable of measuring a touch intensity (pressure), and/or a fingerprint sensor.

According to one or more embodiments of the disclosure, the second display panel 321 may extend along an edge of the first display panel 311. The second display panel 321 may partially surround the frame 400. For example, the second display panel 321 may surround a side portion of the frame 400. An edge of the second display panel 321 and an edge of the first display panel 311 may be adjacent to each other.

According to one or more embodiments of the disclosure, the wearable electronic device 101 may include the sensor module 211. The sensor module 211 may produce an electrical signal or data value corresponding to the internal operation state or external environment state of the wearable electronic device 101. The sensor module 211 may include, e.g., a biometric sensor module 211 (e.g., a heart rate monitoring (HRM) sensor) disposed on the cover part 430 of the frame 400. The wearable electronic device 101 may further include at least one of a sensor module, e.g., a barometric pressure sensor, a magnetic sensor, a grip sensor, a color sensor, an infrared (IR) sensor, a biometric sensor, a temperature sensor, a humidity sensor, or an illuminance sensor.

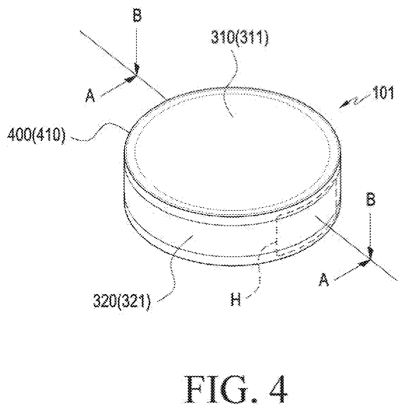

FIG. 4 is a perspective view illustrating the wearable electronic device 101 illustrating the first display panel 311 and the second display panel 321 according to one or more embodiments of the disclosure.

Referring to FIG. 4, the wearable electronic device 101 according to one or more embodiments of the disclosure may include the first display panel 311 and the second display panel 321. At least a portion of an edge of the first display panel 311 may be supported by the front part 410 of the frame 400. The second display panel 321 may extend along an edge of the first display panel 311.

According to one or more embodiments of the disclosure, the frame 400 may include a connection opening H. As an example, the connection opening H may be formed in the front part 410 of the frame 400. The connection opening H may be located at a side portion of the wearable electronic device 101. The second display panel 321 may at least partially cover the connection opening H. The second display panel 321 may be connected to an inside of the wearable electronic device 101 through the connection opening H.

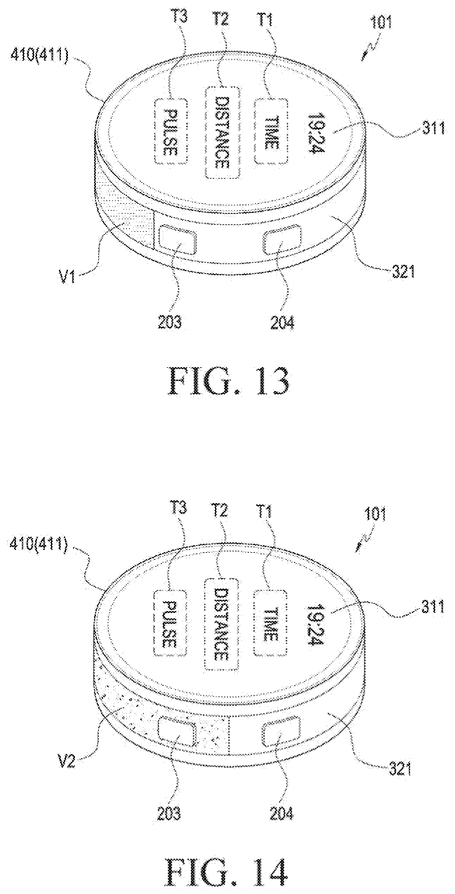

According to one or more embodiments of the disclosure, the second display panel 321 may display various colors and patterns. As an example, the second display panel 321 may display an image input by a user. Alternatively, the second display panel 321 may display an image associated with an image displayed on the first display panel 311. A display control method through the first display panel 311 and the second display panel 321 is described below in detail with reference to FIGS. 13 to 19.

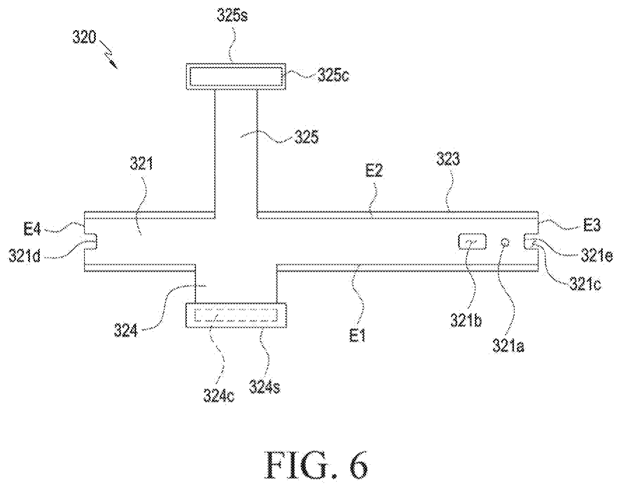

FIG. 5 is a partial cross-sectional view illustrating the wearable electronic device 101 according to one or more embodiments of the disclosure, taken along line A-A′ illustrated in FIG. 4. FIG. 6 illustrates a second display module 320 according to one or more embodiments of the disclosure.

Referring to FIGS. 5 and 6, the wearable electronic device 101 according to one or more embodiments of the disclosure may include a first printed circuit board 510. The first printed circuit board 510 may be disposed inside the frame 400. The first printed circuit board 510 may be located below the first display panel 311. The first printed circuit board 510 may be connected to a battery 270. For example, the first printed circuit board 510 may be located between the first display panel 311 and the battery 270.

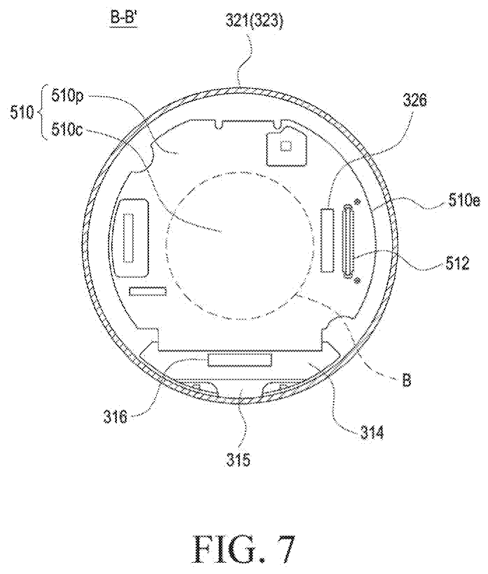

According to one or more embodiments of the disclosure, the first printed circuit board 510 may include a central portion 510c and a peripheral portion 510p. The peripheral portion 510p may surround the central portion 510c. The first printed circuit board 510 may be divided into the central portion 510c and the peripheral portion 510p based on a predetermined boundary B (see FIG. 7). As an example, the central portion 510c of the first printed circuit board 510 may include an area overlapping the battery 270. As an example, the boundary B may extend along an edge of a cover 511 disposed on the first printed circuit board 510, and the central portion 510c and the peripheral portion 510p may be divided based on the boundary B.

According to one or more embodiments of the disclosure, the first printed circuit board 510 may be connected to the first display panel 311. For example, the first printed circuit board 510 may be connected to an edge of the first display panel 311 through a flexible printed circuit board 315 (see FIG. 7) connected to an edge of the first printed circuit board 510.

According to one or more embodiments of the disclosure, a cover 511 may be disposed on one surface of the first printed circuit board 510. The cover 511 may cover electronic components mounted on the one surface of the first printed circuit board 510. As an example, the cover 511 may be located between the first printed circuit board 510 and the battery 270.

According to one or more embodiments of the disclosure, the wearable electronic device 101 may include a second printed circuit board 520. The second printed circuit board 520 may be disposed inside the frame 400. For example, the battery 270 may be disposed between the second printed circuit board 520 and the first printed circuit board 510. The second printed circuit board 520 may be connected to the battery 270. The second printed circuit board 520 may be connected to the second display panel 321 through a second flexible connection member 325.

According to one or more embodiments of the disclosure, the front part 410 of the frame 400 may include a first portion 411 that supports the first display panel 311. The first portion 411 may support a first window 313. The first portion 411 may extend along an edge of the first display panel 311. The first portion 411 may support at least a portion of an edge of the first display panel 311.

According to one or more embodiments of the disclosure, the front part 410 of the frame 400 may include a second portion 412 that supports the second display panel 321. The second portion 412 may extend along an edge of the first display panel 311. For example, the second portion 412 may extend in an annular shape along an edge of the first display panel 311.

According to one or more embodiments of the disclosure, the second portion 412 of the front part 410 of the frame 400 may support the second display panel 321. The second portion 412 may be coupled to the rear part 420. For example, the rear part 420 and the second portion 412 may be adhered through an adhesive member.

According to one or more embodiments of the disclosure, the rear part 420 of the frame 400 may include an inner wall portion 425 protruding toward the first printed circuit board 510. The inner wall portion 425 may be located inside the second portion 412 of the front part 410 of the frame 400. The second portion 412 of the front part 410 may surround the inner wall portion 425 of the rear part 420. The inner wall portion 425 of the rear part 420 may be located inside the connection opening H. The first flexible connection member 324 and the second flexible connection member 325 may pass through the connection opening H and then extend into the inner space of the frame 400 through a space between the second portion 412 of the front part 410 and the inner wall portion 425 of the rear part 420.

According to one or more embodiments of the disclosure, the inner wall portion 425 of the rear part 420 of the frame 400 may be spaced apart from the peripheral portion 510p of the first printed circuit board 510 in one direction (e.g., a direction opposite to the Z-axis direction of FIG. 2). A second display drive chip 326 may be located between a protruding end 425p of the inner wall portion 425 of the rear part 420 and the peripheral portion 510p of the first printed circuit board 510.

According to one or more embodiments of the disclosure, the wearable electronic device 101 may include a speaker K. The speaker K may be disposed inside the frame 400. The speaker K may be supported by the inner wall portion 425 of the frame 400. As an example, the protruding end 425p of the inner wall portion 425 may be bent to support a lower portion of the speaker K.

According to one or more embodiments of the disclosure, the second portion 412 of the front part 410 of the frame 400 may include the connection opening H. The connection opening H may penetrate through the second portion 412. The inner space of the frame 400 may be spatially connected to an outside of the frame 400 through the connection opening H. The connection opening H may be at least partially covered by the second display panel 321.

According to one or more embodiments of the disclosure, the wearable electronic device 101 may include a first flexible connection member 324. As an example, the first flexible connection member may include a flexible printed circuit board. The second display panel 321 and the first printed circuit board 510 may be connected through the first flexible connection member 324. The first flexible connection member 324 may be connected to the peripheral portion 510p (see FIG. 7) of the first printed circuit board 510 through the connection opening H.

According to one or more embodiments of the disclosure, one end of the first flexible connection member 324 may be connected to an edge of the second display panel 321. A connector 324c and a stiffener 324s may be disposed at another end of the first flexible connection member 324. The first flexible connection member 324 may be connected to the first printed circuit board 510 through the connector 324c. The stiffener 324s may allow the connector 324c to be stably connected to the first printed circuit board 510.

According to one or more embodiments of the disclosure, the wearable electronic device 101 may include at least one display drive chip (e.g., display drive chip 326). The display drive chip 326 may be mounted on the first printed circuit board 510. As an example, the display drive chip 326 may be disposed on one surface of the first printed circuit board 510 facing the rear part 420 of the frame 400. The display drive chip 326 may be located adjacent to an area (e.g., the connection part 512 of FIG. 7) of the first printed circuit board 510 to which the first flexible connection member 324 is connected. The display drive chip 326 may be connected to the second display panel 321 through the first flexible connection member 324 and the connector 324c.

According to one or more embodiments of the disclosure, visual information displayed on the second display panel 321 may be controlled by the display drive chip 326. For example, visual information (e.g., text, an image, or an icon) may be displayed through the second display panel 321 by driving at least some pixels of the second display panel 321 by the display drive chip 326.

According to one or more embodiments of the disclosure, the display drive chip 326 may be connected to the second display panel 321 and may be connected to the first display panel 311 through the first printed circuit board 510. Visual information displayed on the first display panel 311 and the second display panel 321 may be respectively controlled by the display drive chip 326. For example, visual information (e.g., text, an image, or an icon) may be displayed through the first display panel 311 by driving at least some pixels of the first display panel 311 by the display drive chip 326, and visual information (e.g., text, an image, or an icon) may be displayed through the second display panel 321 by driving at least some pixels of the second display panel 321 by the display drive chip 326. According to one or more embodiments of the disclosure, the wearable electronic device 101 may include a second flexible connection member 325. As an example, the second flexible connection member 325 may include a flexible printed circuit board. The second display panel 321 and the second printed circuit board 520 may be connected through the second flexible connection member 325. Power supplied from the battery 270 may be supplied to the second display panel 321 through a connector 325c and the second flexible connection member 325. The second flexible connection member 325 may pass through the connection opening H and connect the second printed circuit board 520 and the second display panel 321.

According to one or more embodiments of the disclosure, one end of the second flexible connection member 325 may be connected to an edge of the second display panel 321. A connector 325c and a stiffener 325s may be disposed at another end of the second flexible connection member 325. The second flexible connection member 325 may be connected to the second printed circuit board 520 through the connector 325c. The stiffener 325s may allow the connector 325c to be stably connected to the second printed circuit board 520.

According to one or more embodiments of the disclosure, the wearable electronic device 101 may include a first window 313. The first window 313 may cover the first display panel 311. The first window 313 may be supported by the first portion 411 of the front part 410 of the frame 400. Visual information displayed on the first display panel 311 may be visually exposed to an outside of the wearable electronic device 101 through a substantial portion of the first window 313. As an example, the first window 313 may include ultra-thin glass.

According to one or more embodiments of the disclosure, the wearable electronic device 101 may include a second window 323. Visual information displayed on the second display panel 321 may be visually exposed to an outside of the wearable electronic device 101 through a substantial portion of the second window 323. As an example, the second window 323 may include ultra-thin glass.

According to one or more embodiments of the disclosure, the second window 323 may cover the second display panel 321. The second window 323 may extend from at least a portion of an edge of the second display panel 321. An edge of the second window 323 may be located outside an edge of the second display panel 321. The second window 323 may have an area larger than the second display panel 321.

According to one or more embodiments of the disclosure, an edge of the second window 323 may be adhered to the second portion 412 of the front part 410 of the frame 400 through an adhesive member B1, B2. As an example, the adhesive member B1, B2 may include a double-sided tape. The adhesive member B1, B2 may prevent foreign objects and/or liquid from an outside of the wearable electronic device 101 from entering an inside of the wearable electronic device 101 through the connection opening H.

According to one or more embodiments of the disclosure, the adhesive member B1, B2 may extend along an edge of the second display panel 321. The adhesive member B1, B2 may include a first adhesive member B1 extending along the first longitudinal edge E1 of the second display panel 321. The adhesive member B1, B2 may include a second adhesive member B2 extending along the second longitudinal edge E2 of the second display panel 321.

A wearable electronic device 101 according to one or more embodiments of the disclosure may be assembled through a series of processes. For example, the wearable electronic device 101 may be assembled by disposing the first display panel 311 on the first portion 411 of the front part 410 of the frame 400. The assembly method may then include adhering the second window 323 to the second portion 412 of the front part 410 while passing the flexible connection members 324, 325 through the connection opening H. The assembly method may then include connecting the flexible connection members 324, 325 to the printed circuit boards 510, 520. Thereafter, the wearable electronic device 101 may be assembled by coupling the rear part 420 of the frame 400 to the front part 410.

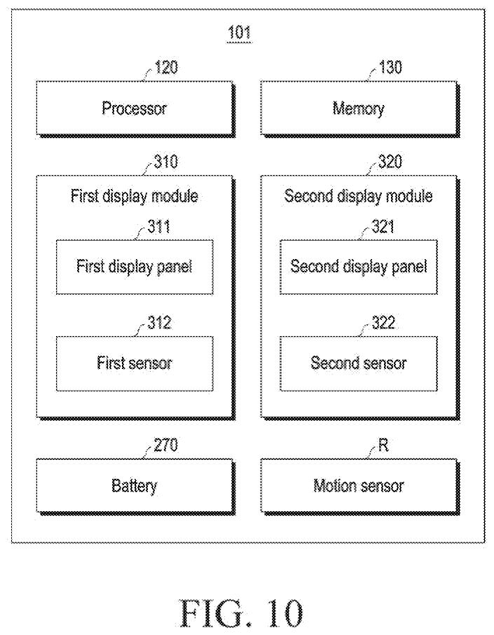

According to one or more embodiments of the disclosure, the wearable electronic device 101 may include a second display module 320 (see FIG. 10). The second display module 320 may include the second display panel 321 and the second window 323. The second window 323 may cover the second display panel 321. The second display panel 321 may include a first longitudinal edge E1 and a second longitudinal edge E2 extending along an edge of the first display panel 311. The second longitudinal edge E2 may extend along the first longitudinal edge E1. As an example, the first longitudinal edge E1 and the second longitudinal edge E2 may extend parallel to each other.

According to one or more embodiments of the disclosure, the second display module 320 may include flexible connection members 324, 325 extending from the second display panel 321. The first flexible connection member 324 may extend from the first longitudinal edge E1 of the second display panel 321. The second flexible connection member 325 may extend from the second longitudinal edge E2 of the second display panel 321.

According to one or more embodiments of the disclosure, the second display panel 321 may include a first through hole 321a (e.g., the microphone hole 205 of FIG. 2). As an example, external sound from outside the wearable electronic device 101 may enter an inside of the wearable electronic device 101 through the first through hole 321a, and the first through hole 321a may be referred to as a microphone hole 321a. As another example, sound generated from a speaker inside the wearable electronic device 101 may be radiated through the first through hole 321a, and the first through hole 321a may be referred to as a speaker hole 321a.

According to one or more embodiments of the disclosure, a breathable first waterproofing member may be disposed in the first through hole 321a. The first waterproofing member may include a mesh of a Gore-Tex material. The first waterproofing member may block liquid or foreign objects from an outside of the wearable electronic device 101 from entering an inside of the wearable electronic device 101 through the first through hole 321a.

According to one or more embodiments of the disclosure, the second display panel 321 may include a second through hole 321b. The second through hole 321b may be located adjacent to the first through hole 321a. A side key button 204 (see FIG. 2) may pass through the second through hole 321b and protrude outside the second window 323.

According to one or more embodiments of the disclosure, the second display panel 321 may include a notch 321e, 321d forming a third through hole 321c. As an example, the third through hole 321c may be located adjacent to the first through hole 321a. A side key button 203 (see FIG. 2) may pass through the third through hole 321c and protrude outside the second window 323.

According to one or more embodiments of the disclosure, the wearable electronic device 101 may include a second waterproofing member and a third waterproofing member. The second waterproofing member and the third waterproofing member may surround the side key buttons 203, 204. The second waterproofing member and the third waterproofing member may be respectively disposed in the second through hole 321b and the third through hole 321c of the second display panel 321. The second waterproofing member may block liquid or foreign objects from an outside of the wearable electronic device 101 from entering. The third waterproofing member may block liquid or foreign objects from an outside of the wearable electronic device 101 from entering. As an example, the second waterproofing member and the third waterproofing member may each include an o-ring member surrounding the side key buttons 203, 204.

According to one or more embodiments of the disclosure, the third through hole 321c may be formed by notches 321e, 321d formed at edges E3, E4 of the second display panel 321. When the second display panel 321 is disposed on the frame 400, a space surrounded by the first notch 321e and the second notch 321d may be referred to as the third through hole 321c. When the second display panel 321 is disposed on the frame 400, the first notch 321e and the second notch 321d may be disposed to abut each other.

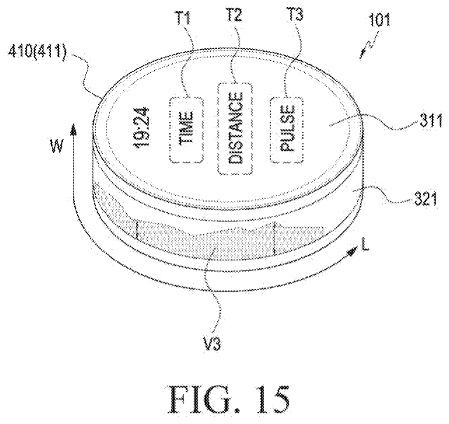

According to one or more embodiments of the disclosure, the first notch 321e may be formed at a first edge E3 of the second display panel 321. The second notch 321d may be formed at a second edge E4 of the second display panel 321. The first edge E3 and the second edge E4 of the second display panel 321 may connect the first longitudinal edge E1 and the second longitudinal edge E2. For example, the longitudinal edges E1, E2 of the second display panel 321 may extend along a length direction L (see FIG. 15) of the second display panel 321, and the edges E3, E4 of the second display panel 321 may extend along a width direction W (see FIG. 15) of the second display panel 321.

According to one or more embodiments of the disclosure, the first notch 321e and the second notch 321d may be aligned along the length direction L (see FIG. 15) of the second display panel 321. The first notch 321e and the second notch 321d may each partially form the third through hole 321c. For example, the first notch 321e and the second notch 321d may contact each other to form an enclosed space.

According to one or more embodiments of the disclosure, the connection opening H may not overlap the plurality of through holes 321a, 321b, 321c. As an example, the connection opening H may be spaced apart from the plurality of through holes 321a, 321b, 321c in the length direction of the second display panel 321. The connection opening H may be formed at a position corresponding to one end of the first flexible connection member 324 and one end of the second flexible connection member 325 connected to the second display panel 321.

According to one or more embodiments of the disclosure, the second window 323 may include a plurality of openings corresponding to the first through hole 321a, the second through hole 321b, and the third through hole 321c. The plurality of openings may be referred to as punch holes. As an example, the plurality of openings corresponding to the first through hole 321a, the second through hole 321b, and the third through hole 321c may each have a shape substantially identical to the first through hole 321a, the second through hole 321b, and the third through hole 321c.

A wearable electronic device 101 according to one or more embodiments of the disclosure may include a battery 270. The battery 270 may be disposed in the inner space of the frame 400. As an example, the battery 270 may be disposed between the first printed circuit board 510 and the second printed circuit board 520. The battery 270 may supply power to components (e.g., the first display panel 311, the second display panel 321) of the wearable electronic device 101.

FIG. 7 is a cross-sectional view illustrating the wearable electronic device 101 according to one or more embodiments of the disclosure, taken along line B-B′ illustrated in FIG. 4.

Referring to FIG. 7, according to one or more embodiments of the disclosure, the wearable electronic device 101 may include a first display drive chip 316. As an example, the first display drive chip 316 may be disposed on a film substrate 314 connected to the first printed circuit board 510, and the first display drive chip 316 may be connected to the first display panel 311 through a flexible printed circuit board 315 connected to the film substrate 314.

According to one or more embodiments of the disclosure, visual information displayed on the first display panel 311 may be controlled by the first display drive chip 316. For example, visual information (e.g., text, an image, or an icon) may be displayed through the first display panel 311 by driving at least some pixels of the first display panel 311 by the first display drive chip 316.

According to one or more embodiments of the disclosure, the wearable electronic device 101 may include a second display drive chip 326. The second display drive chip 326 may be spaced apart from the first display drive chip 316. The second display drive chip 326 may be mounted on the peripheral portion 510p of the first printed circuit board 510. Therefore, the second display drive chip 326 may be disposed at a position closer to the second display panel 321.

According to one or more embodiments of the disclosure, the first printed circuit board 510 may include a connection part 512. The connector 324c of the first flexible connection member 324 may be connected to the connection part 512 of the first printed circuit board 510. The connection part 512 may be located between the second display drive chip 326 and the second display panel 321.

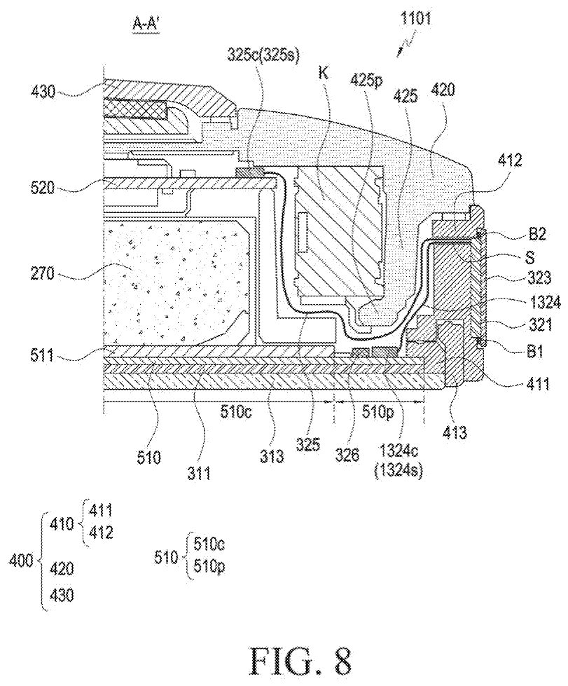

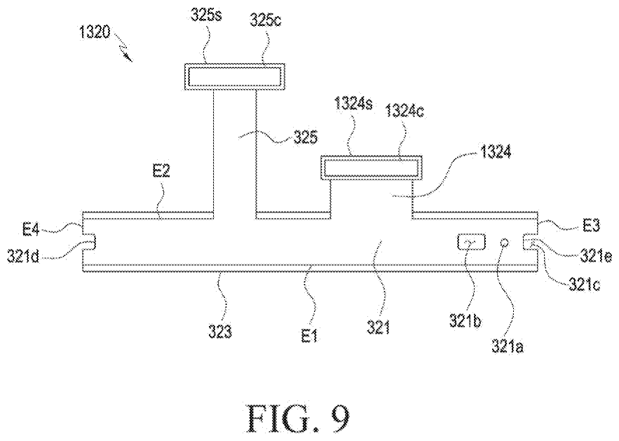

FIG. 8 is a partial cross-sectional view illustrating a wearable electronic device 1101 according to one or more embodiments of the disclosure. FIG. 9 illustrates a second display module 1320 according to one or more embodiments of the disclosure.

Referring to FIGS. 8 and 9, the second display module 1320 according to one or more embodiments of the disclosure is substantially the same as the wearable electronic device 101 and the second display module 320 illustrated in FIGS. 2, 3, 4, 5, 6, and o 7, except for matters relating to a first flexible connection member 1324.

According to one or more embodiments of the disclosure, the second display module 1320 may include a first flexible connection member 1324 connecting the second display panel 321 and the first printed circuit board 510. The second display module 1320 may include a second flexible connection member 325 connecting the second display panel 321 and the second printed circuit board 520.

According to one or more embodiments of the disclosure, a connector 1324c and a stiffener 1324s may be disposed at one end of the first flexible connection member 1324. The first flexible connection member 1324 may be connected to the first printed circuit board 510 through the connector 1324c. The stiffener 1324s may allow the connector 1324c to be stably connected to the first printed circuit board 510.

A wearable electronic device 1101 according to one or more embodiments of the disclosure may include a slot S. The slot S may correspond to the connection opening H of the wearable electronic device 101 illustrated in FIG. 5. The slot S may be formed in the second portion 412 of the front part 410 of the frame 400. The flexible connection members 325, 1324 extending from the second display panel 321 may extend into the inner space of the frame 400 through the slot S.

According to one or more embodiments of the disclosure, the slot S may extend along the second longitudinal edge E2 of the second display panel 321. According to one or more embodiments, the slot S may extend along the first longitudinal edge E1 of the second display panel 321. The slot S may be formed as a single slot through which the flexible connection members 325, 1324 pass, or may be formed as a plurality of (e.g., two) slots through which each of the flexible connection members 324, 1324 passes. The slot S is a passage connecting the inner space of the frame 400 and an external space of the wearable electronic device 1101, and may minimize an area of the passage.

According to one or more embodiments of the disclosure, the slot S may be located inside the second longitudinal edge E2 of the second display panel 321. Therefore, a distance from the second longitudinal edge E2 of the second display panel 321 to the slot S may be minimized, and a length of the flexible connection members 325, 1324 may be minimized.

FIG. 10 is a block diagram illustrating a portion of the wearable electronic device 101 according to one or more embodiments of the disclosure.

Referring to FIG. 10, the wearable electronic device 101 according to one or more embodiments of the disclosure may include a first display module 310 (e.g., the display module 160 of FIG. 1). The first display module 310 may include the first display panel 311 and a first sensor 312. The first sensor 312 may be disposed adjacent to the first display panel 311. The first sensor 312 may include, e.g., a touch sensing circuit and/or a pressure sensor capable of measuring a touch intensity (pressure).

The wearable electronic device 101 according to one or more embodiments of the disclosure may include a second display module 320 (e.g., the display module 160 of FIG. 1). The second display module 320 may include the second display panel 321 and a second sensor 322. The second sensor 322 may be disposed adjacent to the second display panel 321. The second sensor 322 may include, e.g., a touch sensing circuit and/or a pressure sensor capable of measuring a touch intensity (pressure).

According to one or more embodiments of the disclosure, the wearable electronic device 101 may include at least one processor 120 (e.g., the processor 120 of FIG. 1) and memory 130 (e.g., the memory 130 of FIG. 1) storing instructions. The instructions may, when executed by the at least one processor 120, cause the wearable electronic device 101 to perform a function (e.g., outputting an image through the display panels 311, 321).

According to one or more embodiments of the disclosure, the processor 120 may control power supplied from the battery 270 to the display modules 310, 320. The processor 120 may control power (e.g., voltage) supplied from the battery 270 to the first display panel 311 and the second display panel 321.

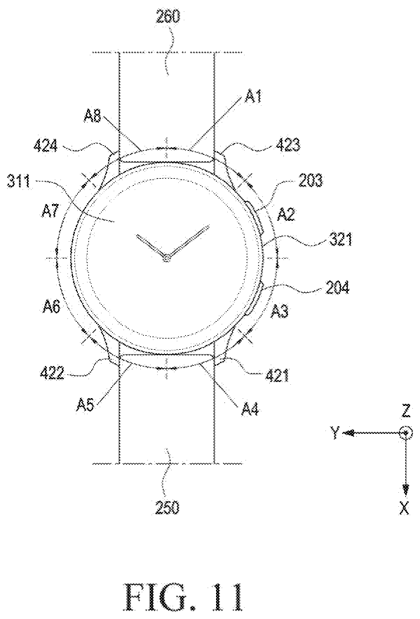

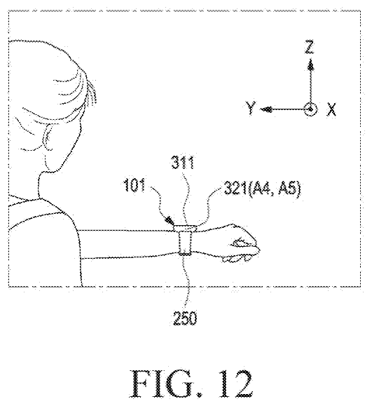

According to one or more embodiments of the disclosure, the wearable electronic device 101 may include a motion sensor R. The motion sensor R may sense a translation motion and a rotation motion of the wearable electronic device 101. The motion sensor R may sense a movement direction of the wearable electronic device 101 in coordinate axes (e.g., X-axis, Y-axis, and Z-axis) of a predetermined coordinate system (e.g., the coordinate system illustrated in FIG. 11). The motion sensor R may sense a rotation direction of the wearable electronic device 101 about a predetermined rotation axis (e.g., X-axis, Y-axis, and Z-axis illustrated in FIG. 11). For example, the motion sensor R may include a 6-axis sensor. The processor 120 may control a display panel 311, 321 on which an image is displayed, or an area of the display panel 311, 321, based on a signal of the wearable electronic device 101 sensed through the motion sensor R. A method of displaying an image on the display panels 311, 321 through the motion sensor R is described in detail with reference to FIG. 12.

According to one or more embodiments of the disclosure, the processor 120 may control an image displayed through the first display panel 311 and/or the second display panel 321. This is described in detail with reference to FIGS. 11 to 15.

According to one or more embodiments of the disclosure, the processor 120 may control an image displayed through the first display panel 311 and/or the second display panel 321 based on an input (e.g., a touch, a gesture, etc.) of a user sensed by the first sensor 312. The processor 120 may control an image displayed through the first display panel 311 and/or the second display panel 321 based on an input (e.g., a touch, a gesture, etc.) of a user sensed by the second sensor 322. This is described in detail with reference to FIGS. 1616 to 1919.

FIG. 11 is a front view illustrating the wearable electronic device 101 illustrating display areas A1, A2, A3, A4, A5, A6, A7, A8 of the first display panel 311 and the second display panel 321 according to one or more embodiments of the disclosure.

Referring to FIG. 11, the second display panel 321 according to one or more embodiments of the disclosure may include a plurality of display areas A1, A2, A3, A4, A5, A6, A7, A8. The plurality of display areas A1, A2, A3, A4, A5, A6, A7, A8 may partially display one image or may respectively display a plurality of images.

The plurality of display areas A1, A2, A3, A4, A5, A6, A7, A8 according to one or more embodiments of the disclosure may be divided with respect to a connection part 423. For example, with respect to one connection part 423 among the plurality of connection parts 421, 422, 423, 424, display areas located on two opposite sides of the connection part 423 may be referred to as a first display area A1 and a second display area A2.

According to one or more embodiments of the disclosure, display areas on two opposite sides of a first connection part 421, divided with respect to the first connection part 421, may be referred to as a third display area A3 and a fourth display area A4. Display areas on two opposite sides of a second connection part 422, divided with respect to the second connection part 422, may be referred to as a fifth display area A5 and a sixth display area A6. Display areas on two opposite sides of a third connection part 423, divided with respect to the third connection part 423, may be referred to as the first display area A1 and the second display area A2. Display areas on two opposite sides of a fourth connection part 424, divided with respect to the fourth connection part 424, may be referred to as a seventh display area A7 and an eighth display area A8.

According to one or more embodiments of the disclosure, each of the plurality of display areas A1, A2, A3, A4, A5, A6, A7, A8 may be electrically connected to the battery 270. The processor 120 (see FIG. 10) may control power supplied from the battery 270 (see FIG. 10) to the plurality of display areas A1, A2, A3, A4, A5, A6, A7, A8. As an example, the processor 120 may supply a voltage higher than a reference voltage to some of the plurality of display areas A1, A2, A3, A4, A5, A6, A7, A8 and supply a voltage lower than the reference voltage to the remaining display areas among the plurality of display areas A1, A2, A3, A4, A5, A6, A7, A8, thereby extending a usage time of the battery 270.

According to one or more embodiments of the disclosure, information selected by a user may be displayed through the plurality of display areas A1, A2, A3, A4, A5, A6, A7, A8. For example, exercise information, various colors, patterns, a UI, etc. may be displayed through the plurality of display areas A1, A2, A3, A4, A5, A6, A7, A8. Further, by displaying an image through some of the plurality of display areas A1, A2, A3, A4, A5, A6, A7, A8 and not displaying an image through the remaining display areas (e.g., by turning off power in some areas or processing in black color), a usage time of the battery 270 (see FIG. 5) may be extended. For example, by not displaying an image through the first display area A1 and the eighth display area A8 to which the wearing member 260 is connected, a usage time of the battery 270 may be extended.

FIG. 12 illustrates a user gazing at an area A4, A5 of the second display panel 321. The coordinate axes illustrated in FIG. 12 may be substantially the same as the coordinate axes set based on the wearable electronic device 101 illustrated in FIG. 11.

Referring to FIG. 12, the wearable electronic device 101 according to one or more embodiments of the disclosure may display an image through some display areas (e.g., the fourth display area A4 and the fifth display area A5 of FIG. 11) of the second display panel 321. The some display areas of the second display panel 321 may be preset by a user. The some display areas of the second display panel 321 may be set differently by a user according to a wearing form of the wearable electronic device 101. FIG. 12 illustrates a case where the some display areas are the fourth display area A4 and the fifth display area A5 of the second display panel 321 illustrated in FIG. 11.

According to one or more embodiments of the disclosure, the wearable electronic device 101 may sense, via the motion sensor R (see FIG. 10), movement of the wearable electronic device 101 caused by flexion or extension of an elbow of a user. As an example, when a user extends an elbow based on a state illustrated in FIG. 12, the motion sensor R may sense that the wearable electronic device 101 rotates about the Z-axis and moves in a direction opposite to the X-axis. As another example, when a user flexes an elbow based on a state illustrated in FIG. 12, the motion sensor R may sense that the wearable electronic device 101 rotates in a direction opposite to a rotation direction about the Z-axis and moves in the X-axis direction.

According to one or more embodiments of the disclosure, when an image is displayed through the some display areas (e.g., the fourth display area A4 and the fifth display area A5 of FIG. 11) among the plurality of display areas A1, A2, A3, A4, A5, A6, A7, A8 of the second display panel 321, the specified image may be output through other display areas (e.g., the third display area A3 or the sixth display area A6 of FIG. 11) of the second display panel 321 spaced apart from the some display areas of the second display panel 321 in a direction opposite to a movement direction (e.g., the X-axis direction) of the wearable electronic device 101 sensed by the motion sensor R (see FIG. 10). As an example, when a user flexes an elbow based on a state illustrated in FIG. 12, the processor 120 (see FIG. 10) may output the specified image through the third display area A3 (see FIG. 11) based on a movement direction of the wearable electronic device 101 sensed by the motion sensor R. As another example, when a user extends an elbow based on a state illustrated in FIG. 12, the processor 120 (see FIG. 10) may output the specified image through the sixth display area A6 (see FIG. 11) based on a movement direction of the wearable electronic device 101 sensed by the motion sensor R.

FIGS. 13, 14, and 15 15 are perspective views illustrating the wearable electronic device 101 illustrating images displayed through the second display panel 321 according to one or more embodiments of the disclosure.

Referring to FIGS. 13 and 14, the first display panel 311 according to one or more embodiments of the disclosure may display text T1, T2, T3. As an example, when a specific application (e.g., an exercise application) is executed, the first display panel 311 may display text T1, T2, T3. For example, the text T1, T2, T3 may include elapsed time (TIME), travel distance (DISTANCE), and a pulse of a user (PULSE).

The second display panel 321 according to one or more embodiments of the disclosure may display a visual object V1, V2 that is extended or contracted along a length direction L of the second display panel 321. As an example, the visual object V1, V2 may include an image corresponding to data that quantitatively increases or decreases.

According to one or more embodiments of the disclosure, a second visual object V2 illustrated in FIG. 14 illustrates an extended state compared to a first visual object V1 illustrated in FIG. 13. The first visual object V1 illustrated in FIG. 13 illustrates a contracted state compared to the second visual object V2 illustrated in FIG. 14.

According to one or more embodiments of the disclosure, the visual object V1, V2 may include an image corresponding to a current speed of a user when the user walks or runs while wearing the wearable electronic device 101. Therefore, information (e.g., a current speed) may be intuitively conveyed to a user through expansion or contraction of the visual object V1, V2 through the second display panel 321. The visual object V1, V2 may be extended as the current speed of the user increases, and the visual object V1, V2 may be contracted as the current speed of the user decreases. A text object O1, O2 may be displayed on the second display panel 321 as text (e.g., 5 km/h or 10 km/h) corresponding to preset data.

As another example, the visual object V1, V2 may intuitively convey a hiking altitude of a user to the user. The visual object V1, V2 may be extended as a current altitude of the user increases, and the visual object V1, V2 may be contracted as a current altitude of the user decreases. The text object O1, O2 may be displayed on the second display panel 321 as text (e.g., 500 m) corresponding to preset data.

As another example, the visual object V1, V2 may intuitively convey exercise time information to a user. The visual object V1, V2 may be extended from an exercise start time input by a user. The text object O1, O2 may be displayed on the second display panel 321 as text (e.g., 10 minutes or 20 minutes) corresponding to preset data.

According to one or more embodiments of the disclosure, the visual object V1, V2 may effectively convey information to a user through color change. For example, when a user walks or runs while wearing the wearable electronic device 101, a red-colored visual object V1, V2 may be displayed when a speed of the user is faster than a pre-stored recommended speed, and a blue-colored visual object V1, V2 may be displayed when a speed of the user is slower than the pre-stored recommended speed.

According to one or more embodiments of the disclosure, a visual object V1, V2 that extends or contracts may be displayed through some display areas A1, A2, A3, A4 among the plurality of display areas A1, A2, A3, A4, A5, A6, A7, A8, and information or a notification regarding the wearable electronic device 101 may be displayed through the remaining areas A5, A6, A7, A8. Alternatively, power of the battery 270 (see FIG. 5) may be efficiently used by not outputting an image through the remaining areas A5, A6, A7, A8 (e.g., by partially turning off power or displaying black color).

According to one or more embodiments of the disclosure, a visual object V1, V2 that extends or contracts may be displayed through some display areas A3, A4, A5, A6 among the plurality of display areas A1, A2, A3, A4, A5, A6, A7, A8, and information or a notification regarding the wearable electronic device 101 may be displayed through the remaining areas A1, A2, A7, A8. Alternatively, power of the battery 270 (see FIG. 5) may be efficiently used by not outputting an image through the remaining areas A1, A2, A7, A8 (e.g., by partially turning off power or displaying black color).

According to one or more embodiments of the disclosure, a first/second sensor 312, 322 may include a plurality of sensing circuits capable of sensing an input in each of the areas A1 to A8 of the second display panel 322. According to one or more embodiments of the disclosure, a plurality of first sensors 312 and a plurality of second sensors 322 may be provided.

Referring to FIG. 15, the second display panel 321 according to one or more embodiments of the disclosure may display a third visual object V3 configured to extend or contract along a length direction L and a width direction W of the second display panel 321. The third visual object V3 may extend or contract along the length direction L of the second display panel 321 corresponding to first information that increases or decreases. The third visual object V3 may extend or contract along the width direction W of the second display panel 321 corresponding to second information that increases or decreases.

For example, the first information may include exercise time of a user, and the second information may include consumed calories, a current speed, and/or a heart rate. Therefore, calories consumed according to exercise time, a speed according to exercise time, or a heart rate according to exercise time may be intuitively conveyed to a user through the third visual object V3.

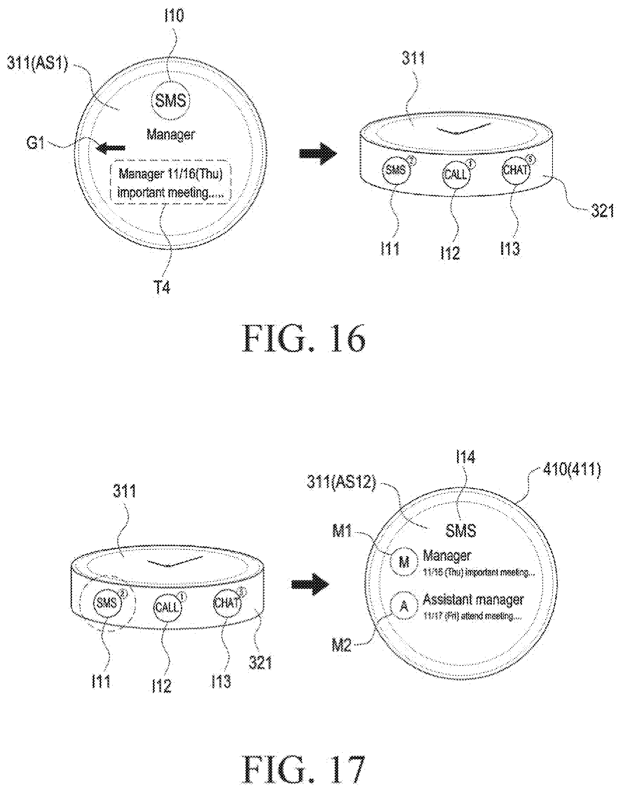

FIG. 16 is a view illustrating that an indicator I11 of an application displayed on the first display panel 311 is displayed on the second display panel 321 by a gesture G1 of a user according to one or more embodiments of the disclosure.

Referring to FIG. 16, a control method of the wearable electronic device 101 (see FIG. 10) according to one or more embodiments of the disclosure may include displaying, via the first display panel 311, an application execution screen AS1 of an application (e.g., the application 146 of FIG. 1). As an example, the application may include a short message service (SMS) application, a call application, a chat application, etc.

According to one or more embodiments of the disclosure, the application execution screen AS1 may include an icon I10 corresponding to the application (e.g., SMS). The application execution screen AS1 may include text T4 displayed by an input of a user when the application (e.g., SMS) is executed.

According to one or more embodiments of the disclosure, the application execution screen AS1 may include a screen displayed on the first display panel 311 when the application is automatically executed based on data received from an outside of the wearable electronic device 101 through the communication module 190 (see FIG. 1). As another example, the application execution screen AS1 may include a screen displayed on the first display panel 311 when the application is executed by an input of a user.

According to one or more embodiments of the disclosure, the control method of the wearable electronic device 101 may include sensing, via the first sensor 312, a gesture or an input applied to the first display panel 311 when the application execution screen AS1 corresponding to the application is displayed via the first display panel 311. For example, the first sensor 312 may sense a touch of a user. As another example, the first sensor 312 may sense a swipe gesture G1 of touching the first display panel 311 and then sweeping in a specific direction while maintaining contact.

According to one or more embodiments of the disclosure, the control method of the wearable electronic device 101 may include sensing, via the first sensor 312, a swipe gesture G1 which is input on the first display panel 311 and directed toward the second display panel 321. As an example, the wearable electronic device 101 may sense, via the first sensor 312, a swipe gesture G1 directed from an area of the first display panel 311 toward an edge of the first display panel 311.

According to one or more embodiments of the disclosure, the control method of the wearable electronic device 101 may include displaying, via the second display panel 321, an indicator I11, I12, I13 corresponding to the application, based on the swipe gesture G1 sensed by the first sensor 312. For example, the indicator I11 may include an icon I10 of the application included in the application execution screen AS1. As another example, the indicator I11 may be different from the icon I10 of the application included in the application execution screen AS1.

According to one or more embodiments of the disclosure, the control method of the wearable electronic device 101 may include displaying, via the second display panel 321, predetermined information together with the indicator I11, I12, I13. For example, the wearable electronic device 101 may display, via the second display panel 321, a number (e.g., 2) of text messages not identified by a user together with a first indicator I11 corresponding to a text message application. As another example, the wearable electronic device 101 may display, via the second display panel 321, a number (e.g., 1) of missed calls together with a second indicator I12 corresponding to a call application.

According to one or more embodiments of the disclosure, the control method of the wearable electronic device 101 may include displaying, via the first display panel 311, a screen other than the application execution screen AS1 (e.g., a background screen) when the indicator(s) of the application is displayed on the second display panel 321 based on the swipe gesture G1. Therefore, a user may operate the wearable electronic device 101 through the first display panel 311 and the first sensor 312.

Therefore, information about the application (e.g., text message, call, chat, etc.) may be stored through the indicator(s) I11, I12, I13 displayed on the second display panel 321. According to one or more embodiments of the disclosure, a user may identify through the indicator(s) I11, I12, I13 displayed on the second display panel 321 that there is unidentified information related to a specific application.

FIG. 17 is a view illustrating that an application execution screen AS12 corresponding to the indicator I11 displayed on the second display panel 321 is displayed on the first display panel 311 by an input of a user according to one or more embodiments of the disclosure.

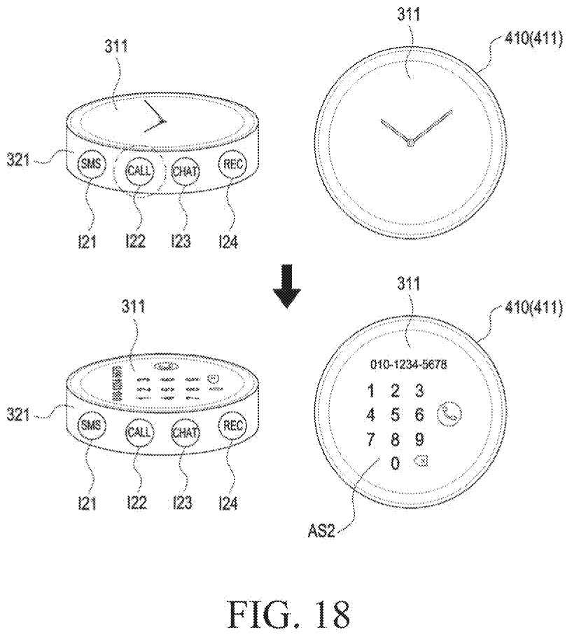

Referring to FIG. 17, a control method of the wearable electronic device 101 according to one or more embodiments of the disclosure may include displaying, via the second display panel 321, indicator(s) I11, I12, I13 corresponding to an application (e.g., text message, call, chat, etc.). As an example, the indicator(s) I11, I12, I13 may be displayed on the second display panel 321 by an input (e.g., the swipe gesture G1 of FIG. 16) of a user. As another example, referring to FIG. 18, the indicator(s) I11, I12, I13 may also be displayed on the second display panel 321 regardless of an input of a user.

According to one or more embodiments of the disclosure, the control method of the wearable electronic device 101 may include displaying, via the second display panel 321, predetermined information together with the indicator I11, I12, I13. For example, a number (e.g., 2) of text messages not identified by a user may be displayed together with the first indicator I11 corresponding to a text message application. As another example, a number (e.g., 1) of missed calls may be displayed together with the second indicator I12 corresponding to a call application.

According to one or more embodiments of the disclosure, when the indicator(s) I11, I12, I13 is displayed on the second display panel 321, the wearable electronic device 101 may sense, via the second sensor 322, an input (e.g., a touch) applied on the second display panel 321. For example, the wearable electronic device 101 may sense, via the second sensor 322, a touch of a user on the indicator(s) I11, I12, I13.

According to one or more embodiments of the disclosure, the control method of the wearable electronic device 101 may include displaying, via the first display panel 311, an application execution screen AS12 of the application (e.g., text message application) corresponding to the indicator I11, based on an input (e.g., a touch) on the indicator I11 sensed by the second sensor 322.

According to one or more embodiments of the disclosure, FIGS. 16 and 17 illustrate a text message application as an example, but the application execution screen AS1 illustrated in FIG. 16 and the application execution screen AS12 illustrated in FIG. 17 may be different. The application execution screen AS12 illustrated in FIG. 17 may include an icon I14 corresponding to a text message application and a plurality of text messages M1, M2. The text T4 illustrated in FIG. 16 may correspond to one M1 of the plurality of text messages M1, M2. According to one or more embodiments of the disclosure, the application execution screens AS1, AS12 illustrated in FIGS. 16 and 17 may be the same as each other.

Therefore, a case where a user checks a message, a call, or a messenger notification with a watch is often a circumstance where it is difficult to check a phone, such as during exercise or a meeting. Therefore, a use case may be presented in which a message, a call, or a messenger notification that needs to be read in detail after the work is finished is swiped to the left, stored, and retrieved later.

FIG. 18 is a view illustrating that an application execution screen AS2 is displayed on the first display panel 311 by an input of a user on an indicator I22 displayed on the second display panel 321 according to one or more embodiments of the disclosure.

Referring to FIG. 18, a control method of the wearable electronic device 101 according to one or more embodiments of the disclosure may include displaying, via the second display panel 321, indicators I21, I22, I23, I24 of a plurality of applications (e.g., short message service (SMS), call (CALL), chat (CHAT), and recording (REC)). The plurality of indicators I21, I22, I23, I24 may be disposed along the length direction L (see FIG. 15) of the second display panel 321.

According to one or more embodiments of the disclosure, the control method of the wearable electronic device 101 may include sensing, via the second sensor 322, an input (e.g., a touch) on the plurality of indicators I21, I22, I23, I24 displayed on the second display panel 321. As an example, the wearable electronic device 101 may sense, via the second sensor 322, a touch of a user on one indicator I22.

A control method of the wearable electronic device 101 according to one or more embodiments of the disclosure may include displaying, via the first display panel 311, an application execution screen AS2 of an application (e.g., call (CALL) application) corresponding to the one indicator I22, based on an input (e.g., a touch) sensed by the second sensor 322.

Therefore, a user may easily and quickly access and execute the corresponding application through the indicators I21, I22, I23, I24 of the plurality of applications displayed on the second display panel 321.

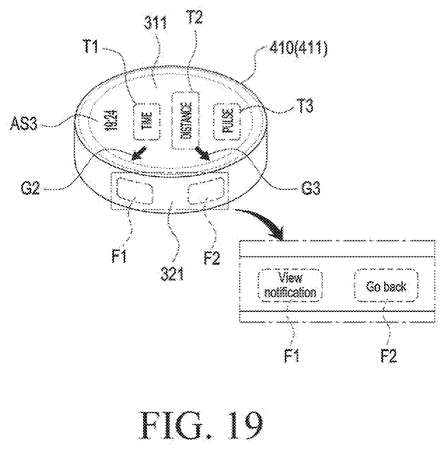

FIG. 19 is a view illustrating that a function of the wearable electronic device 101 is performed by a gesture G2, G3 of a user corresponding to a guide indicator F1, F2 displayed on the second display panel 321 according to one or more embodiments of the disclosure.

Referring to FIG. 19, a control method of the wearable electronic device 101 according to one or more embodiments of the disclosure may include displaying, via the first display panel 311, an application execution screen AS3 of a predetermined application (e.g., an exercise application). According to one or more embodiments of the disclosure, the wearable electronic device 101 may display, via the first display panel 311, a background screen of the wearable electronic device 101.

An application execution screen AS3 according to one or more embodiments of the disclosure may include text T1, T2, T3. The text T1, T2, T3 may include information conveyed to a user through the predetermined application (e.g., exercise application). For example, the text T1, T2, T3 may include elapsed time (TIME), travel distance (DISTANCE), and a pulse of a user (PULSE).

According to one or more embodiments of the disclosure, when the application execution screen AS3 is displayed via the first display panel 311 or the background screen is displayed, a user may input a command for control of the wearable electronic device 101 or control of the predetermined application through the first sensor 312 and/or the second sensor 322.

According to one or more embodiments of the disclosure, the control method of the wearable electronic device 101 may include displaying, via the second display panel 321, a guide indicator F1, F2 corresponding to a specific function for controlling the wearable electronic device 101. The guide indicator F1, F2 may include text or an image corresponding to the specific function. For example, a first guide indicator F1 may be “view notification,” and a second guide indicator F2 may be “go back.”

According to one or more embodiments of the disclosure, the control method of the wearable electronic device 101 may include sensing, via the sensor 312, a swipe gesture G2, G3 which is input on the first display panel 311 and directed toward the guide indicator F1, F2. The swipe gesture G2, G3 may include a gesture of sweeping from an area of the first display panel 311 toward the guide indicator F1, F2. For example, the control method of the wearable electronic device 101 may include sensing, via the first sensor 312, a swipe gesture G2, G3 directed from a center of the first display panel 311 toward a portion of an edge of the first display panel 311 corresponding to the guide indicator F1, F2.

According to one or more embodiments of the disclosure, the control method of the wearable electronic device 101 may include performing the specific function corresponding to the guide indicator F1, F2, based on the swipe gesture G2, G3 sensed by the sensor 312. For example, when a swipe gesture directed toward the first guide indicator F1 is sensed through the first sensor 312, the wearable electronic device 101 may perform a “view notification” function to operate the predetermined application. As another example, when a swipe gesture directed toward the second guide indicator F2 is sensed through the first sensor 312, the wearable electronic device 101 may perform a “go back” function to operate the predetermined application.

A function corresponding to the guide indicator F1, F2 according to one or more embodiments of the disclosure may be set by a user differently from the embodiment of the disclosure. Further, the guide indicator F1, F2 may be displayed on the second display panel 321 or may not be displayed according to a selection of a user.

Therefore, the wearable electronic device 101 may provide guidance on a function for operation of the wearable electronic device 101 (go back, open menu, etc.) or a function for operation of an application (e.g., start measurement, stop measurement, etc.) through the guide indicator F1, F2 displayed through the second display panel 321. A user may easily operate the wearable electronic device 101 or an application through the guide indicator F1, F2.

As wearable electronic devices become downsized and programs (e.g., applications, etc.) included in wearable electronic devices become sophisticated and diversified, it is difficult to effectively convey information to a user with a display of a limited size. Accordingly, much research is being conducted on a method of displaying information through a display.

A problem to be solved in the disclosure may be to provide a structure for installing a plurality of (e.g., two) displays facing different directions.

A problem to be solved in the disclosure may be to effectively convey information to a user through a plurality of (e.g., two) adjacent displays.

Problems to be solved in the disclosure are not limited to the above-mentioned problems, and may be variously extended without departing from the spirit and scope of the disclosure.

A wearable electronic device according to various embodiments of the disclosure may provide a structure for installing a plurality of (e.g., two) displays facing different directions.

A wearable electronic device according to various embodiments of the disclosure may effectively convey information to a user by displaying a UI of a program (e.g., an application) through a plurality of (e.g., two) adjacent displays.

The effects obtainable from the disclosure are not limited to the above-mentioned effects, and other effects not mentioned is clearly understood by those of ordinary skill in the art to which the disclosure belongs from the description below.

A wearable electronic device 101 according to one or more embodiments of the disclosure may be configured to be worn on a body of a user, e.g., on a wrist of a user.

An electronic device 101 according to one or more embodiments of the disclosure may include a first display panel 311.

A wearable electronic device 101 according to one or more embodiments of the disclosure may include a frame 400 that supports the first display panel 311.

According to one or more embodiments of the disclosure, the first display panel 311 may be disposed at a front side of the frame 400.

A wearable electronic device 101 according to one or more embodiments of the disclosure may include a second display panel 321.

According to one or more embodiments of the disclosure, the second display panel 321 may be disposed at a lateral side of the frame 400.

According to one or more embodiments of the disclosure, the second display panel 321 may at least partially surround the frame 400.

A wearable electronic device 101 according to one or more embodiments of the disclosure may include a first printed circuit board 510 disposed inside the frame 400.

According to one or more embodiments of the disclosure, the first printed circuit board 510 may be connected to the first display panel 311 and the second display panel 321.

A wearable electronic device 101 according to one or more embodiments of the disclosure may include a connection opening H disposed in the frame 400.

According to one or more embodiments of the disclosure, the connection opening H may be at least partially covered by the second display panel 321.

A wearable electronic device 101 according to one or more embodiments of the disclosure may include a first flexible connection member 324 extending from the second display panel 321.

According to one or more embodiments of the disclosure, the first flexible connection member 324 may be connected to the peripheral portion 510p of the first printed circuit board 510 through the connection opening H.

A wearable electronic device 101 according to one or more embodiments of the disclosure may include a second printed circuit board 520 located inside the frame 400.

A wearable electronic device 101 according to one or more embodiments of the disclosure may include a second flexible connection member 325 extending from the second display panel 321.

According to one or more embodiments of the disclosure, the second flexible connection member 325 may be connected to the second printed circuit board 520 through the connection opening H.

According to one or more embodiments of the disclosure, the second flexible connection member 325 may be configured to supply power to the second display panel 321.

According to one or more embodiments of the disclosure, the second display panel 321 may include a first longitudinal edge E1 extending along an edge of the first display panel 311.

According to one or more embodiments of the disclosure, the first flexible connection member 324 may extend from the first longitudinal edge E1.

According to one or more embodiments of the disclosure, the second display panel 321 may include a second longitudinal edge E2 extending along the first longitudinal edge E1.

According to one or more embodiments of the disclosure, the second flexible connection member 325 may extend from the second longitudinal edge E2.

According to one or more embodiments of the disclosure, the second display panel 321 may include a longitudinal edge E2 from which the first flexible connection member 1324 and the second flexible connection member 325 extend.

According to one or more embodiments of the disclosure, the connection opening H may be formed as a slot S extending along the longitudinal edge E2 of the second display panel 321.

According to one or more embodiments of the disclosure, the wearable electronic device 101 may include a display drive chip (DDI) 326 disposed on the peripheral portion 510p of the first printed circuit board 510 and connected to the second display panel 321 through the first flexible connection member 324.

According to one or more embodiments of the disclosure, the wearable electronic device 101 may include a through hole 321b, 321c formed in the second display panel 321 and spaced apart from the connection opening H in a length direction of the second display panel 321.

According to one or more embodiments of the disclosure, the second display panel 321 may include a first edge E3 including a first notch 321e.

According to one or more embodiments of the disclosure, the second display panel 321 may include a second edge E4 extending along the first edge E3 and including a second notch 321d.

According to one or more embodiments of the disclosure, the first notch 321e and the second notch 321d may be aligned in the length direction L of the second display panel 321 and at least partially form the through hole 321c.

According to one or more embodiments of the disclosure, the frame 400 may include a front part 410 on which the first display panel 311 and the second display panel 321 are disposed.

According to one or more embodiments of the disclosure, the frame 400 may include a rear part 420 facing the first display panel 311 and coupled to the front part 410.

According to one or more embodiments of the disclosure, the frame 400 may include at least one connection part 421, 422, 423, 424 protruding outward from the rear part 420.

According to one or more embodiments of the disclosure, the second display panel 321 may include a first display area A1 and a second display area A2 divided with respect to the connection part 423.

According to one or more embodiments of the disclosure, the second display panel 321 may include a plurality of display areas A1, A2, A3, A4, A5, A6, A7, A8 disposed along the lateral side of the frame 400.

According to one or more embodiments of the disclosure, the plurality of display areas A1, A2, A3, A4, A5, A6, A7, A8 may be each electrically connected to a power source 270.

According to one or more embodiments of the disclosure, the wearable electronic device 101 may be configured to display an image through some of the plurality of display areas A1, A2, A3, A4, A5, A6, A7, A8, and turn off the remaining display areas or apply a voltage lower than a reference voltage to some of the display areas.

According to one or more embodiments of the disclosure, the wearable electronic device 101 may include a motion sensor R configured to sense a movement direction and a rotation direction of the wearable electronic device 101.

According to one or more embodiments of the disclosure, the wearable electronic device 101 may include at least one processor 120 and memory 130 storing instructions.

According to one or more embodiments of the disclosure, the instructions may, when executed by the at least one processor 120, cause the wearable electronic device 101 to display a specified image through a first display area A4, A5 of the second display panel 321.

According to one or more embodiments of the disclosure, the instructions may, when executed by the at least one processor 120, cause the wearable electronic device 101 to sense, via the motion sensor R, movement of the wearable electronic device 101 caused by flexion or extension of an elbow of a user.

According to one or more embodiments of the disclosure, the instructions may, when executed by the at least one processor 120, cause the wearable electronic device 101 to output the specified image through a second display area A3, A6 of the second display panel 321 spaced apart from the first display area A4, A5 of the second display panel 321 in a direction opposite to a movement direction of the wearable electronic device 101 sensed by the motion sensor R.

According to one or more embodiments of the disclosure, the instructions may, when executed by the at least one processor 120, cause the wearable electronic device 101 to display, via the second display panel 321, a visual object V3 configured to extend or contract along a length direction L and a width direction W of the second display panel 321.

According to one or more embodiments of the disclosure, the wearable electronic device 101 may include a first display module 310 including the first display panel 311 and a first sensor 312.

According to one or more embodiments of the disclosure, the instructions may, when executed by the at least one processor 120, cause the wearable electronic device 101 to display, via the first display panel 311, an application execution screen AS1 corresponding to an application.

According to one or more embodiments of the disclosure, the instructions may, when executed by the at least one processor 120, cause the wearable electronic device 101 to

According to one or more embodiments of the disclosure, the instructions may, when executed by the at least one processor 120, cause the wearable electronic device 101 to sense, via the first sensor 312, a swipe gesture G1 which is input on the first display panel 311 and directed toward the second display panel 321, while the application execution screen AS1 is displayed on the first display panel 311.

According to one or more embodiments of the disclosure, the instructions may, when executed by the at least one processor 120, cause the wearable electronic device 101 to display, via the second display panel 321, an indicator I11 corresponding to the application, based on the swipe gesture G1 sensed by the first sensor 312.

According to one or more embodiments of the disclosure, the wearable electronic device 101 may include a second display module 320 including the second display panel 321 and a second sensor 322.

According to one or more embodiments of the disclosure, the instructions may, when executed by the at least one processor 120, cause the wearable electronic device 101 to sense, via the second sensor 322, an input which is input on the second display panel 321, while the indicator I11 is displayed on the second display panel 321.

According to one or more embodiments of the disclosure, the instructions may, when executed by the at least one processor 120, cause the wearable electronic device 101 to display, via the first display panel 311, an application execution screen AS1, AS12 of the application corresponding to the indicator I11, based on the input sensed by the second sensor 322.

According to one or more embodiments of the disclosure, the instructions may, when executed by the at least one processor 120, cause the wearable electronic device 101 to display, via the second display panel 321, a plurality of indicators I21, I22, I23, I24 corresponding to a plurality of applications.

According to one or more embodiments of the disclosure, the instructions may, when executed by the at least one processor 120, cause the wearable electronic device 101 to sense, via the sensor 322, an input on one indicator I22 among the plurality of indicators I21, I22, I23, I24 displayed on the second display panel 321.

According to one or more embodiments of the disclosure, the instructions may, when executed by the at least one processor 120, cause the wearable electronic device 101 to display, via the first display panel 311, an application execution screen AS2 corresponding to the one indicator I22, based on the input sensed by the sensor 322.

According to one or more embodiments of the disclosure, the instructions may, when executed by the at least one processor 120, cause the wearable electronic device 101 to display, via the second display panel 321, a guide indicator F1, F2 corresponding to a function for controlling the wearable electronic device 101.

According to one or more embodiments of the disclosure, the instructions may, when executed by the at least one processor 120, cause the wearable electronic device 101 to sense, via the sensor 312, a swipe gesture G2, G3 which is input on the first display panel 311 and directed toward the guide indicator F1, F2.

According to one or more embodiments of the disclosure, the instructions may, when executed by the at least one processor 120, cause the wearable electronic device 101 to perform the function corresponding to the guide indicator F1, F2, based on the swipe gesture G2, G3 sensed by the sensor 312.

According to one or more embodiments of the disclosure, the instructions may, when executed by the at least one processor 120, cause the electronic device 101 to display, via the first display panel 311, an application execution screen AS3 corresponding to an application.

According to one or more embodiments of the disclosure, the instructions may, when executed by the at least one processor 120, cause the electronic device 101 to display, via the second display panel 321, a guide indicator F2 corresponding to a function executed in the application, when the application execution screen AS3 is displayed on the first display panel 311.

According to one or more embodiments of the disclosure, the instructions may, when executed by the at least one processor 120, cause the electronic device 101 to sense, via the first sensor 312, a swipe gesture G3 directed toward the guide indicator F2 from the first display panel 311 on which the application execution screen AS3 is displayed.

According to one or more embodiments of the disclosure, the instructions may, when executed by the at least one processor 120, cause the electronic device 101 to perform the function corresponding to the guide indicator F2, based on the swipe gesture G3 sensed by the first sensor 312.

According to one or more embodiments of the disclosure, a control method of the wearable electronic device 101 may include displaying, via the first display panel 311, an application execution screen AS1 corresponding to an application.

According to one or more embodiments of the disclosure, the control method of the wearable electronic device 101 may include sensing, via the first sensor 312, a swipe gesture G1 which is input on the first display panel 311 and directed toward the second display panel 321, while the application execution screen AS1 is displayed on the first display panel 311.

According to one or more embodiments of the disclosure, the control method of the wearable electronic device 101 may include displaying, via the second display panel 321, an indicator I11 corresponding to the application, based on the swipe gesture G1 sensed by the first sensor 312.

According to one or more embodiments of the disclosure, the control method of the wearable electronic device 101 may include sensing, via the second sensor 322, an input which is input on the second display panel 321, while the indicator I11 is displayed on the second display panel 321.

According to one or more embodiments of the disclosure, the control method of the wearable electronic device 101 may include displaying, via the first display panel 311, an application execution screen AS1, AS12 of the application corresponding to the indicator I11, based on the input sensed by the second sensor 322.

According to one or more embodiments of the disclosure, the control method of the wearable electronic device 101 may include displaying, via the second display panel 321, a plurality of indicators I21, I22, I23, I24 corresponding to a plurality of applications.

According to one or more embodiments of the disclosure, the control method of the wearable electronic device 101 may include sensing, via the second sensor 322, an input on one indicator I22 among the plurality of indicators I21, I22, I23, I24 displayed on the second display panel 321.

According to one or more embodiments of the disclosure, the control method of the wearable electronic device 101 may include displaying, via the first display panel 311, an application execution screen AS2 corresponding to the one indicator I22, based on the input sensed by the second sensor 322.

According to one or more embodiments of the disclosure, the control method of the wearable electronic device 101 may include displaying, via the second display panel 321, a first guide indicator F1 corresponding to a first function for controlling the wearable electronic device 101.

According to one or more embodiments of the disclosure, the control method of the wearable electronic device 101 may include sensing, via the first sensor 312, a swipe gesture G2 which is input on the first display panel 311 and directed toward the first guide indicator F1.

According to one or more embodiments of the disclosure, the control method of the wearable electronic device 101 may include performing the first function corresponding to the first guide indicator F1, based on the swipe gesture G2 sensed by the first sensor 312.

According to one or more embodiments of the disclosure, a storage medium may include computer-readable instructions, and the instructions may, when executed by at least one processor 120 of the wearable electronic device 101, cause the wearable electronic device 101 to perform operations.

According to one or more embodiments of the disclosure, the operation may include displaying, via the first display panel 311, an application execution screen AS1 corresponding to an application.

According to one or more embodiments of the disclosure, the operation may include sensing, via the first sensor 312, a swipe gesture G1 which is input on the first display panel 311 and directed toward the second display panel 321, while the application execution screen AS1 is displayed on the first display panel 311.

According to one or more embodiments of the disclosure, the operation may include displaying, via the second display panel 321, an indicator I11 corresponding to the application, based on the swipe gesture G1 sensed by the first sensor 312.

While example embodiments of the disclosure have been shown and described, it will be apparent to those of ordinary skill in the art that various changes in form and detail may be made thereto without departing from the spirit and scope of the disclosure as defined by the following claims.

What is claimed is:

1. A wearable electronic device configured to be worn on a wrist of a user, the wearable electronic device comprising:
a frame having a connection opening therein;
a first display panel at a front side of the frame;
a second display panel at a lateral side of the frame and at least partially covering the connection opening;
a first printed circuit board inside the frame and connected to the first display panel and the second display panel; and
a first flexible connection member connecting the second display panel and the first printed circuit board through the connection opening.

2. The wearable electronic device of claim 1, further comprising:
a display drive chip on a peripheral portion of the first printed circuit board and connected to the second display panel through the first flexible connection member.

3. The wearable electronic device of claim 1, further comprising:
a second printed circuit board inside the frame; and
a second flexible connection member extending from the second display panel and connected to the second printed circuit board through the connection opening, the second flexible connection member configured to supply power to the second display panel.

4. The wearable electronic device of claim 3, wherein the second display panel comprises:
a first longitudinal edge extending along an edge of the first display panel, wherein the first flexible connection member extends from the first longitudinal edge; and
a second longitudinal edge extending along the first longitudinal edge, wherein the second flexible connection member extends from the second longitudinal edge.

5. The wearable electronic device of claim 3, wherein the second display panel comprises a longitudinal edge extending along an edge of the first display panel, and
wherein the first flexible connection member and the second flexible connection member extend from the longitudinal edge.

6. The wearable electronic device of claim 5, wherein the connection opening comprises a slot extending along the longitudinal edge of the second display panel.

7. The wearable electronic device of claim 1, wherein the second display panel has a through hole therein, and the through hole is spaced apart from the connection opening in a longitudinal direction of the second display panel.

8. The wearable electronic device of claim 7, wherein the second display panel comprises:
a first edge comprising a first notch; and
a second edge extending along the first edge and comprising a second notch, and
wherein the first notch and the second notch are aligned in the longitudinal direction of the second display panel and at least partially comprise the through hole.

9. The wearable electronic device of claim 1, wherein the frame comprises:
a front part, wherein the first display panel and the second display panel are on the front part;
a rear part facing the first display panel and coupled to the front part; and
at least one connection part protruding outwards from the rear part, and
wherein the second display panel comprises a first display area and a second display area divided with respect to the connection part.

10. The wearable electronic device of claim 1, wherein the second display panel comprises a plurality of display areas arranged along the lateral side of the frame and each display area of the plurality of display areas is connected to a power source, and
wherein the wearable electronic device is configured to display an image through some of the plurality of display areas, and turn off remaining display areas of the plurality of display areas or apply a voltage lower than a reference voltage to the remaining display areas of the plurality of display areas.

11. The wearable electronic device of claim 1, further comprising:
a motion sensor configured to sense a movement direction and a rotation direction of the wearable electronic device;
at least one processor; and
memory storing instructions,
wherein the instructions, when executed by the at least one processor, cause the wearable electronic device to:
display an image through a first display area of the second display panel;
sense, via the motion sensor, movement of the wearable electronic device caused by flexion or extension of an elbow of the user; and
output the image through a second display area of the second display panel spaced apart from the first display area in a direction opposite to the movement direction of the wearable electronic device sensed by the motion sensor.

12. The wearable electronic device of claim 1, further comprising:
a first sensor;
at least one processor; and
memory storing instructions,
wherein the instructions, when executed by the at least one processor, cause the wearable electronic device to:
display, via the first display panel, an application execution screen corresponding to an application;
sense, via the first sensor, a swipe gesture which is input on the first display panel and directed toward the second display panel, while the application execution screen is displayed on the first display panel; and
display, via the second display panel, an indicator corresponding to the application, based on the swipe gesture sensed by the first sensor.

13. The wearable electronic device of claim 12, further comprising:
a second sensor,
wherein the instructions, when executed by the at least one processor, cause the wearable electronic device to:
sense, via the second sensor, an input which is input on the second display panel, while the indicator is displayed on the second display panel; and
display, via the first display panel, an application execution screen of the application corresponding to the indicator, based on the input sensed by the second sensor.

14. The wearable electronic device of claim 1, further comprising:
a sensor;
at least one processor; and
memory storing instructions, wherein the instructions, when executed by the at least one processor, cause the wearable electronic device to:
display, via the second display panel, a plurality of indicators corresponding to a plurality of applications;
sense, via the sensor, an input on one indicator among the plurality of indicators displayed on the second display panel; and
display, via the first display panel, an application execution screen corresponding to the one indicator, based on the input sensed by the sensor.

15. The wearable electronic device of claim 1, further comprising:
a sensor;
at least one processor; and
memory storing instructions, wherein the instructions, when executed by the at least one processor, cause the wearable electronic device to:
display, via the second display panel, a guide indicator corresponding to a function for controlling the wearable electronic device;
sense, via the sensor, a swipe gesture which is input on the first display panel and directed toward the guide indicator; and
perform the function corresponding to the guide indicator, based on the swipe gesture sensed by the sensor.

16. A control method of a wearable electronic device, the wearable electronic device comprising a first display module including a first display panel and a first sensor, and a second display module including a second display panel and a second sensor, the control method of a wearable electronic device comprising:
displaying, via the first display panel, an application execution screen corresponding to an application;
sensing, via the first sensor when the application execution screen is displayed on the first display panel, a swipe gesture which is input on the first display panel and directed toward the second display panel; and
displaying, via the second display panel, an indicator corresponding to the application, based on the swipe gesture sensed by the first sensor.

17. The control method of claim 16, further comprising:
sensing, via the second sensor when the indicator is displayed on the second display panel, an input which is input on the second display panel; and
displaying, via the first display panel, an application execution screen of the application corresponding to the indicator, based on the input sensed by the second sensor.

18. The control method of claim 16, further comprising:
displaying, via the second display panel, a plurality of indicators corresponding to a plurality of applications;
sensing, via the second sensor, an input on one indicator among the plurality of indicators displayed on the second display panel; and
displaying, via the first display panel, an application execution screen corresponding to the one indicator, based on the input sensed by the second sensor.

19. The control method of claim 18, further comprising:
displaying, via the second display panel, a first guide indicator corresponding to a first function for controlling the wearable electronic device;
sensing, via the first sensor, a swipe gesture which is input on the first display panel and directed toward the first guide indicator; and
performing the first function corresponding to the first guide indicator, based on the swipe gesture sensed by the first sensor.

20. A storage medium storing computer-readable instructions that, when executed by at least one processor of a wearable electronic device, cause the wearable electronic device to perform operations,
wherein the wearable electronic device comprises a first display module including a first display panel and a first sensor, and a second display module including a second display panel and a second sensor, and
wherein the operations comprise:
displaying, via the first display panel, an application execution screen corresponding to an application;
sensing, via the first sensor when the application execution screen is displayed on the first display panel, a swipe gesture which is input on the first display panel and directed toward the second display panel; and
displaying, via the second display panel, an indicator corresponding to the application, based on the swipe gesture sensed by the first sensor.
